(19) United States
(12) Patent Application Publication
(10) Pub. No.: US 2017/0050656 A1
(43) Pub. Date: Feb. 23, 2017

(54) SYSTEM FOR ASSESSMENT OF WIND-INDUCED TRAIN BLOW-OVER RISK

(71) Applicants: Sridhar Dasaratha, Bangalore (IN); Vignesh TS, Bangalore (IN); Landon Anthony Lockhart, Chicago, IL (US); Krishna Kumar Swaminathan, Bangalore (IN); Justin Scudder Borntraeger, Chicago, IL (US)

(72) Inventors: Sridhar Dasaratha, Bangalore (IN); Vignesh TS, Bangalore (IN); Landon Anthony Lockhart, Chicago, IL (US); Krishna Kumar Swaminathan, Bangalore (IN); Justin Scudder Borntraeger, Chicago, IL (US)

(21) Appl. No.: 14/832,816

(22) Filed: Aug. 21, 2015

(51) Int. Cl. B61L 99/00; G06N 99/00

(52) U.S. Cl. CPC B61L 99/00; G06N 99/005

(57) ABSTRACT

In various example embodiments, a method and system for assessment of wind-induced train blow-over risk are presented.

### TECHNICAL FIELD

Embodiments of the present disclosure relate generally to data processing and, more particularly, but not by way of limitation, to a method and system for assessment of wind-induced train blow-over risk.

### BACKGROUND

Conventionally, blow-over risk is determined by identifying a blow-over risk wind speed for a train and comparing that wind speed to a forecasted wind speed for a region through which the train will pass. If the forecasted wind speed for the region exceeds the risk wind speed for the train, the train is halted.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system suitable for assessment of wind-induced train blow-over risk, according to some example embodiments.

FIG. 2 is a block diagram illustrating modules of a computer system suitable for assessment of wind-induced train blow-over risk, according to some example embodiments.

FIG. 3 shows three graphs of wind speed at weather stations, illustrating example data suitable for assessment of wind-induced train blow-over risk, according to some example embodiments.

FIG. 4 is a diagram illustrating terrain and weather stations in relation to track segments, according to some example embodiments.

FIG. 5 is a flow diagram illustrating operations of a computer system suitable for assessment of wind-induced train blow-over risk, according to some example embodiments.

FIG. 6 is a flow diagram illustrating operations of a computer system suitable for assessment of wind-induced train blow-over risk, according to some example embodiments.

FIG. 7 is a flow diagram illustrating operations of a computer system suitable for assessment of wind-induced train blow-over risk, according to some example embodiments.

FIG. 8 is a flow diagram illustrating operations of a computer system suitable for assessment of wind-induced train blow-over risk, according to some example embodiments.

FIG. 9 is a flow diagram illustrating operations of a computer system suitable for assessment of wind-induced train blow-over risk, according to some example embodiments.

FIG. 10 is a flow diagram illustrating operations of a computer system suitable for assessment of wind-induced train blow-over risk, according to some example embodiments.

FIG. 11 is a block diagram illustrating an example of a software architecture suitable for assessment of wind-induced train blow-over risk that may be installed on a machine, according to some example embodiments.

FIG. 12 illustrates a diagrammatic representation of a machine in the form of a computer system within which a set of instructions may be executed for causing the machine to assess wind-induced train blow-over risk, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Anemometers measure wind speed and direction at a set of locations. For example, the wind speed and direction may be sampled every second or every minute and stored on a hard drive or solid state memory device. The stored data is used to determine a predicted wind speed and direction at the location of each anemometer at a future time. The predicted wind speed may be determined based on the current wind speed, an average of the wind speed over a previous period of time (e.g., 30 minutes, 60 minutes, or one week), a prediction based on an autoregressive equation generated from previous wind speeds, or any suitable combination thereof. Similarly, the predicted wind direction may be determined based on the current wind direction, an average of the wind direction over a previous period of time (e.g., 30 minutes, 60 minutes, or one week), a prediction based on an autoregressive equation generated from previous wind direction, or any suitable combination thereof. The autoregressive equations may be based on previous wind speed, previous wind direction, time of day, day of year, temperature or temperature forecast, or any suitable combination thereof.

A vehicle (e.g., train, truck, or automobile) has a blow-over rating. The vehicle has an increased probability of being blown-over when a cross-wind, blowing perpendicularly to the direction of motion of the vehicle, has a speed exceeding the blow-over rating of the vehicle. In some example embodiments, each car of a train has a blow-over rating, and the blow-over rating of the train is determined from the blow-over ratings of the cars making up the train (e.g., the lowest blow-over rating of the cars may be used as the blow-over rating of the train).

A system for assessment of wind-induced train blow-over risk uses predicted wind speeds and directions at one or more locations to generate a predicted wind speed and direction for one or more track segments. Based on the blow-over rating of a train planning to traverse the track segments and the predicted wind speed and direction for the track segments, a blow-over risk for the train is generated. The generated blow-over risk is reported to one or more of: a conductor of the train, a controller of the train, and a positive train control system. The positive train control system may be associated with one or more of the track segments, the train, or both.

As compared to prior art systems that do not use wind direction in generating alerts, one or more of the methodologies described herein may allow trains to run when winds are high but blowing in a direction parallel to the direction of motion of the train. Accordingly, trains may be allowed to continue on schedule with little or no increase in risk using one or more of the methodologies described when they would be stopped using prior art systems. This represents an improvement to one or more of blow-over risk assessment systems, train scheduling systems, and train management systems.

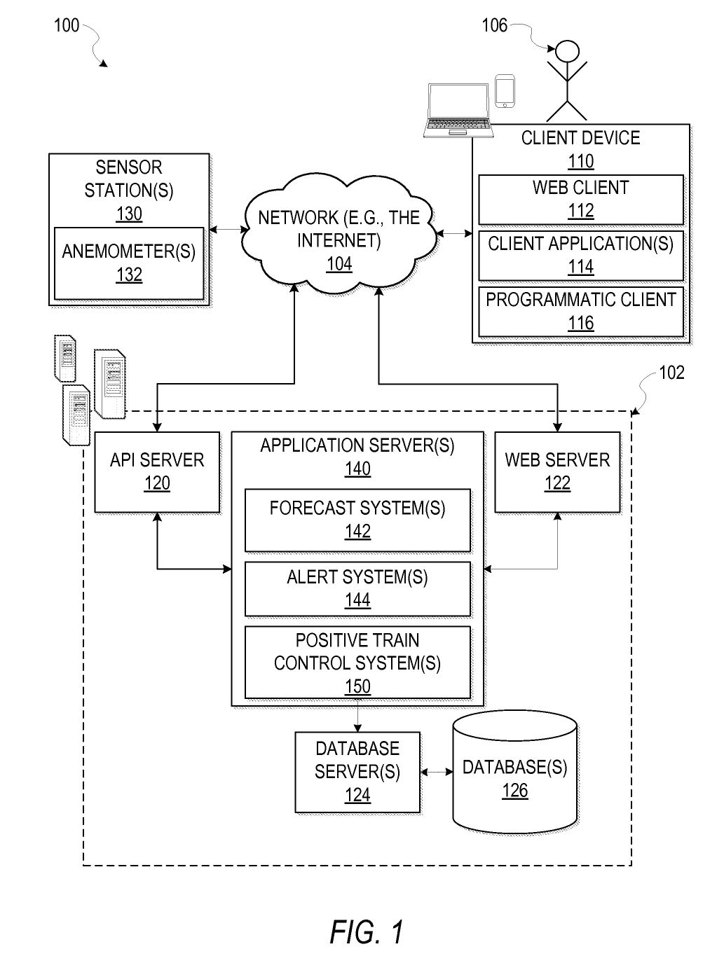

With reference to FIG. 1, an example embodiment of a high-level client-server-based network architecture 100 is shown. A networked system 102 provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), a client application 114, and a programmatic client 116 executing on the client device 110.

The client device 110 may comprise, but is not limited to, a mobile phone, desktop computer, laptop, portable digital assistant (PDA), smart phone, tablet, ultra book, netbook, multi-processor system, microprocessor-based or programmable consumer electronics, or any other communication device that a user may utilize to access the networked system 102. In some embodiments, the client device 110 may comprise a display module (not shown) to display information (e.g., in the form of user interfaces). The client device 110 may be a device of a user that is used to monitor or control one or more trains. In one embodiment, the networked system 102 is a network-based system for assessment of wind-induced train blow-over risk. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each client device 110 may include one or more applications (also referred to as “apps”) such as, but not limited to, a web browser, a messaging application, an electronic mail (email) application, a train control application, and the like. In some embodiments, if the train control application is included in a given client device 110, then this application is configured to locally provide the user interface and at least some of the functionalities with the application configured to communicate with the networked system 102, on an as needed basis, for data or processing capabilities not locally available (e.g., access to a database of information about trains, tracks, and anemometers, to authenticate a user, to communicate with a train, train controller, or positive train control system). Conversely, if the train control application is not included in the client device 110, the client device 110 may use its web browser to access the wind-induced train blow-over risk assessment system (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user 106 provides input (e.g., touch screen input or alphanumeric input) to the client device 110 and the input is communicated to the networked system 102 via the network 104. In this instance, the networked system 102, in response to receiving the input from the user 106, communicates information to the client device 110 via the network 104 to be presented to the user 106. In this way, the user 106 can interact with the networked system 102 using the client device 110.

An application program interface (API) server 120 and a web server 122 are coupled to, and provide programmatic and web interfaces respectively to, one or more application servers 140. The application server(s) 140 host one or more forecast systems 142 and alert systems 144, each of which comprises one or more modules or applications and each of which may be embodied as hardware, software, firmware, or any combination thereof. The application server(s) 140 are, in turn, shown to be coupled to one or more database servers 124 that facilitate access to one or more information storage repositories or database(s) 126. In an example embodiment, the database(s) 126 are storage devices that store information to be accessed by the forecast system(s) 142, the alert system(s) 144, and the positive train control system(s) 150.

Additionally, one or more anemometers 132, communicating with or integrated into sensor station(s) 130, are shown as having programmatic access to the networked system 102 via the programmatic interface provided by the API server 120. For example, the sensor station(s) 130, transmitting information to the networked system 102, provides data stored in the database(s) 126 by the database server(s) 124 for processing by the forecast system(s) 142 in generating a wind vector prediction.

The forecast system(s) 142 provide wind vector forecasts to the users 106 that access the networked system 102, the alert system(s) 144, the positive train control system(s) 150, or any suitable combination thereof. The alert system(s) 144 may generate an alert to the client device 110 based on the predicted wind vector. The alert may be displayed on a display device (e.g., a liquid crystal display (LCD) screen) of the client device 110. While the forecast system(s) 142 and alert system(s) 144 are shown in FIG. 1 to both form part of the networked system 102, it will be appreciated that, in alternative embodiments, each system 142 and 144 may form part of a communication or control service that is separate and distinct from the networked system 102. In some embodiments, the positive train control system(s) 150 form part of the alert system(s) 144.

The positive train control system(s) 150 provides functionality operable to control one or more trains. For example, the positive train control system(s) 150 may halt or slow a train based on the predicted wind vector. In some example embodiments, the positive train control system(s) 150 communicates with the forecast system(s) 142 (e.g., accessing wind vector forecasts) and alert system(s) 144 (e.g., causing the alert system(s) 144 to generate an alert to notify a conductor that the positive train control system(s) 150 is reducing the speed of the conductor's train).

Further, while the client-server-based network architecture 100 shown in FIG. 1 employs a client-server architecture, the present inventive subject matter is, of course, not limited to such an architecture, and could equally well find application in a distributed, or peer-to-peer, architecture system, for example.

The web client 112 may access the various forecast, alert, and positive train control systems 142, 144 and 150 via the web interface supported by the web server 122. Similarly, the programmatic client 116 accesses the various services and functions provided by the forecast and alert systems 142 and 144 via the programmatic interface provided by the API server 120.

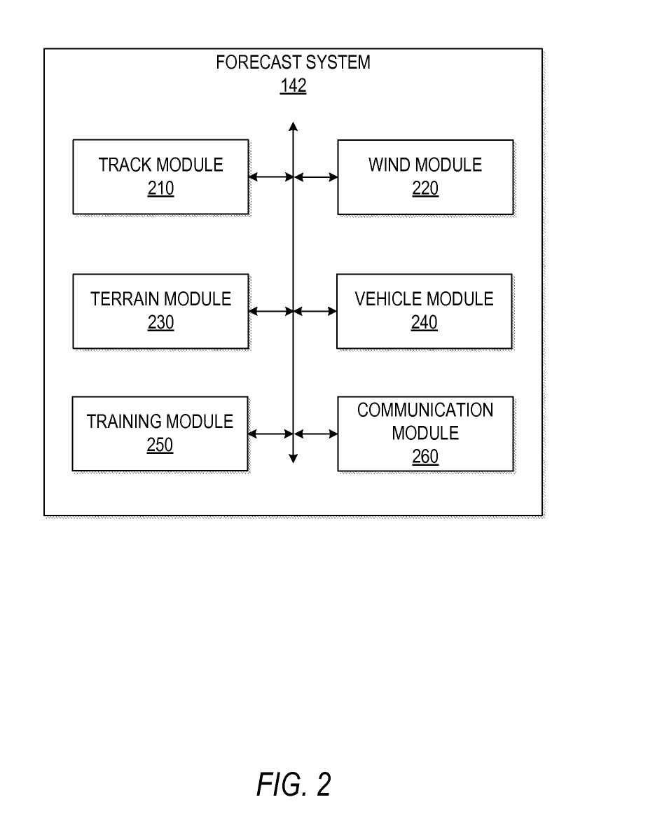

FIG. 2 is a block diagram illustrating modules of the forecast system 142 suitable for assessing wind-induced train blow-over risk, according to some example embodiments. As shown in FIG. 2, the forecast system 142 includes a track module 210, a wind module 220, a terrain module 230, a vehicle module 240, a training module 250, and a communication module 260.

The track module 210 accesses track data. For example, a railroad company's track may be divided into segments of equal length (e.g., one mile segments), divided into segments of varying length, wherein each segment has an approximately constant direction, or divided in another manner. As another example, data may be stored for various points along the track (e.g., mileposts) and the data for the intervening track segments determined from the bounding point data. As used herein, “track segment” may refer to either a point along a track without length or to a segment of track having a length, unless the context indicates otherwise.

The wind module 220 accesses wind data for one or more anemometers (e.g., anemometer(s) 132) and generates a predicted wind vector for one or more track segments or locations. To generate the predicted wind vector for each track segment, the wind module 220 accesses a predicted wind vector for one or more anemometers associated with the track segment. For example, data for a large number of anemometers may be available, and the set of anemometers within a predefined distance of the track segment may be associated with the track segment. In some example embodiments, terrain impacts the association of anemometers with track segments. For example, an anemometer on the other side of a mountain from a track segment may not be associated with the track segment even though the anemometer is within the predefined distance from the track segment. The predicted wind vector for each track segment may be generated by the wind module 220, generated by the sensor station(s) 130, generated by another system, or any suitable combination thereof.

The terrain module 230 accesses data regarding terrain of track segments, sensor stations, areas between track segments and sensor stations, or any suitable combination thereof. For example, terrain may be classified as flat, water, mountain, forest, city, or any suitable combination thereof. The wind module 220 may use the terrain data in determining the wind vector forecast at the track segment, determining or modifying the wind vector forecast for the weather stations, or any suitable combination thereof. In some example embodiments, each type of terrain is associated with a set of values used in the prediction of peak wind speed at sensor stations or track segments in the terrain. For example, an elevation and a wind friction coefficient may be associated with each terrain type.

The vehicle module 240 accesses data regarding one or more vehicles using the track. For example, trains and train cars may have wind rating data stored in the database(s) 126. As another example, engineering drawings or physical descriptions may be stored in the database(s) 126, from which the vehicle module 240, using a physics simulator, can derive wind ratings for the vehicles.

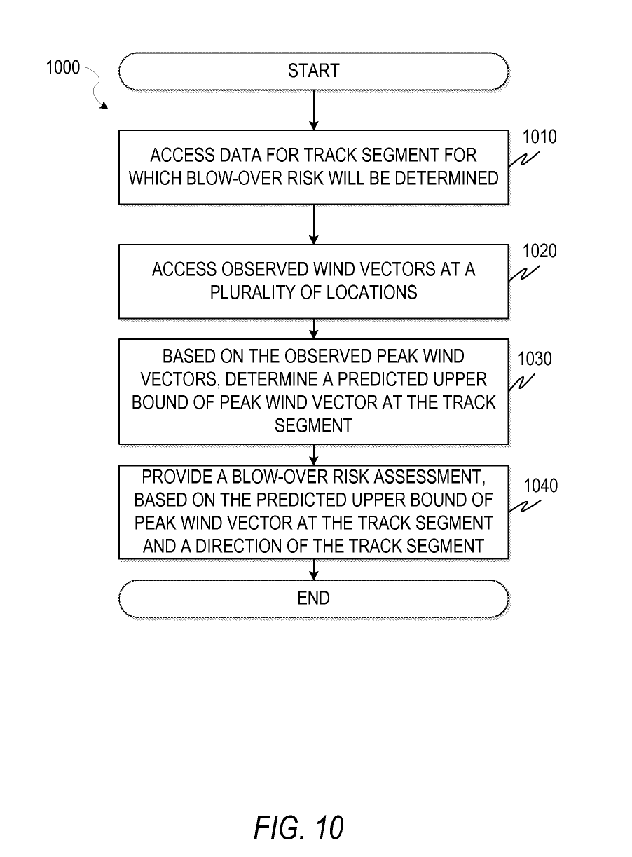

The training module 250 trains a forecasting algorithm using historical wind observations at sensor stations and values derived from those observations. Example forecasting models are discussed in more detail with respect to the process 1000 of FIG. 10, below.

The communication module 260 sends data to and receives data from other systems (e.g., the systems shown in FIG. 1). For example, the communication module 260 may receive data from the sensor station(s) 130 and send data to the alert system(s) 144, positive train control system(s) 150, client device 110, or any suitable combination thereof. In some example embodiments, communications from the communication module 260 cause the display of a user interface on the client device 110. For example, the communication module 260 may communicate a web page to a web browser of the client device 110. The web browser parses the web page to generate a user interface on the client device 110, for display to the user 106.

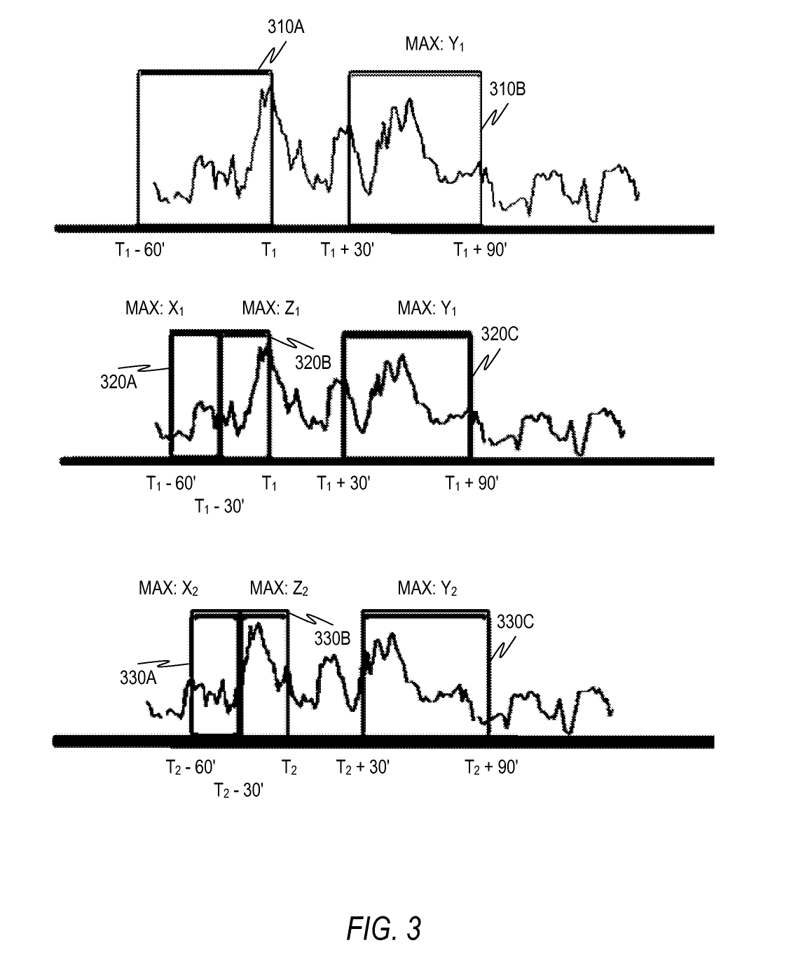

FIG. 3 shows three graphs of wind speed at sensor stations, illustrating example data suitable for assessment of wind-induced train blow-over risk, according to some example embodiments. The first wind speed graph includes two boxed areas, 310A and 310B. The boxed area 310A covers a time from T₁ to T₁−60 minutes. The boxed area 310B covers a time from T₁+30 minutes to T₁+90 minutes. The data in each graph may be used as part of an auto-regression analysis of past data. For example, a modeling equation may be generated that uses 60 minutes of data prior to a present point in time to predict a maximum wind speed in the 60 minutes beginning 30 minutes in the future. Accordingly, the modeling equation can be fed the data in the boxed area 310A and the predicted maximum wind speed compared against the actual maximum wind speed measured in the boxed area 310B.

The second wind speed graph of FIG. 3 shows three boxed areas, 320A, 320B, and 320C. The boxed area 320A covers a time from T₁−30 minutes to T₁−60 minutes. The boxed area 320B covers a time from T₁ to T₁−30 minutes. The boxed area 320C covers a time from T₁+30 minutes to T₁+90 minutes. A modeling equation may be generated that uses the peak wind speed of the time window in the boxed area 320A (e.g., X₁) and the peak wind speed of the time window in the boxed area 320B (e.g., Z₁) to predict a peak wind speed in the boxed area 320C (e.g., Y₁). Accordingly, the modeling equation can be fed the data in the boxed areas 320A and 320B, fed the values for X₁ and Z₁, or both, and the generated predicted peak wind speed compared against the actual peak wind speed, Y₁, measured in the boxed area 320C.

The third wind speed graph of FIG. 3 shows three boxed areas, 330A, 330B, and 330C. The boxed area 330A covers a time from T₂−30 minutes to T₂−60 minutes. The boxed area 330B covers a time from T₂ to T₂−30 minutes. The boxed area 330C covers a time from T₂+30 minutes to T₂+90 minutes. As can be seen by comparison of the last two wind speed graphs, the underlying wind data is unchanged, but T₂ is after T₁. Thus, the distinct boxed areas 330A, 330B, and 330C, when used in conjunction with the boxed areas 320A, 320B, and 320C, provide a second set of data points for generating and testing the modeling equation. An iterative process may be used that repeatedly fits the parameters of the modeling equation until the measured error is reduced below a threshold, a maximum number of iterations is reached, or a suitable combination thereof.

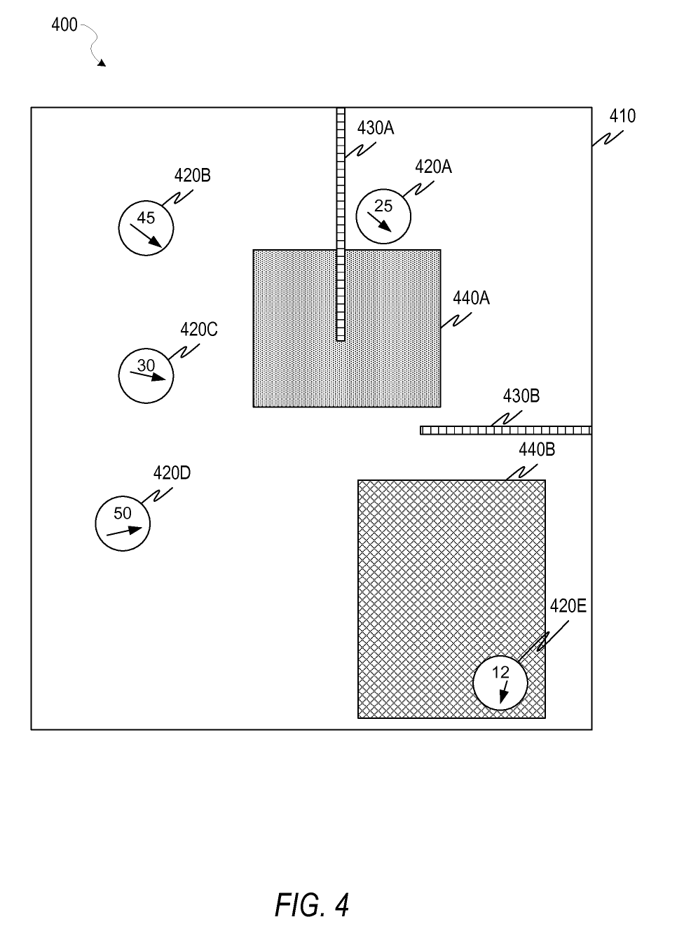

FIG. 4 is a diagram 400 illustrating terrain and sensor stations in relation to track segments, according to some example embodiments. As shown in FIG. 4, the diagram 400 includes region 410, sensor stations 420A-420E, track segments 430A and 430B, and regions 440A and 440B. For simplicity, no other track segments within the region 410 are shown, but may be present. Regions 410, 440A, and 440B are indicated using different patterns. Each pattern, in this example embodiment, corresponds to a different terrain type. Thus, each of regions 410, 440A, and 440B may have a different corresponding modifier applied by the terrain module 230 or the wind module 220 in determining a predicted peak wind vector for a sensor station or track segment. For example, the sensor station 420E, in the region 440B, may have a different terrain modifier applied than the sensor stations 420A-420D, in the region 410. Similarly, the track segment 430A, including a portion within the region 440A, may have a different terrain modifier applied than the track segment 430B, entirely within the region 410.

The sensor stations 420A-420E are shown along with representations of predicted peak wind vectors at their locations. Each predicted peak wind vector includes a speed (e.g., in miles per hour) and a direction, indicated by an arrow.

In some example embodiments, the forecast system(s) 142 determines a predicted peak wind vector along the track segment 430A by averaging the predicted peak wind vectors of sensor stations within a predetermined distance (e.g., 30 miles) of the track segment 430A. By way of example, sensor stations 420A, 420B, and 420C may be considered to be within the predetermined distance. In some example embodiments, the average is taken using scalar math. Accordingly, since the total peak wind speed at the three stations is 45+25+30=100, the average peak wind speed at the track segment 430A is 33⅓. In other example embodiments, the average is taken using vector math. As a result, since the predicted direction is not identical at each of the three sensor stations 420A-420C, the length of the resulting vector will be less than 100, and the average peak vector at the track segment 430A will be less than 33⅓ (e.g., 30). The terrain of the region 440A may be used to modify the predicted peak value by using an attenuation factor. For example, if the region 440A corresponds to a forest region that reduces wind speed by 40% relative to open ground, the calculated peak wind speed may be multiplied by 0.6.

In some example embodiments, the predicted peak wind speed values at the sensor stations 420A-420C are combined using weights. For example, since the sensor station 420A is closer to the track segment 430A than the sensor station 420C is, the weight for the sensor station 420A may be higher than the weight for the sensor station 420C. The weight may be linear (e.g., directly proportional to the inverse of the distance from the sensor station to the track segment), quadratic (e.g., proportional to the square of the inverse of the distance from the sensor station to the track segment), determined by a best fit algorithm (e.g., by using a mobile sensor at various points along the track to determine best fit weighting values), or any suitable combination thereof.

As another example, sensor stations 420A and 420E may be considered to be within the predetermined distance of the track segment 430B. As discussed with respect to the track segment 430A, the predicted peak wind speed at the track segment 430B may be determined based on the wind speeds reported at the sensor stations 420A and 420E. In this example, the sensor station 420E is within the region 440B, having a different terrain modifier. Accordingly, the predicted peak wind speed at the sensor station 420E may be modified prior to being averaged with the predicted peak wind speed at the sensor station 420A. For example, if the region 440B is a city region in which tall buildings tend to increase (all buildings will decrease the wind speed as they will block the wind) the wind speed by 20% relative to open ground, the predicted peak wind speed at the sensor station 420E may be multiplied by 0.83 to generate an equivalent predicted peak wind speed on open ground.

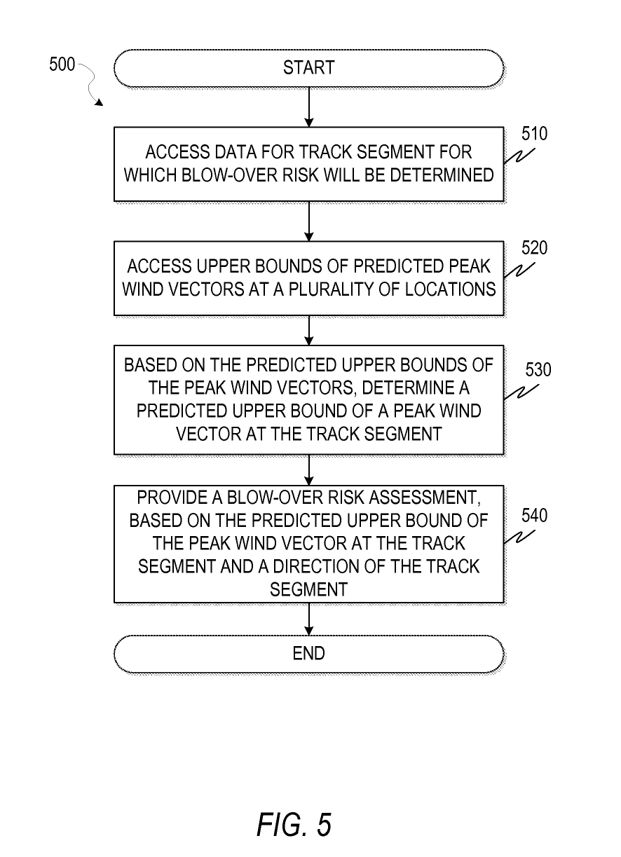

FIG. 5 is a flow diagram illustrating operations of a computer system implementing a process 500 suitable for assessment of wind-induced train blow-over risk, according to some example embodiments. By way of example and not limitation, the operations of the process 500 are described as being performed by the modules of FIG. 2.

In operation 510, the track module 210 accesses data for a track segment for which blow-over risk will be determined. The track segment may be identified based on a train schedule. For example, a train may be scheduled to cross a certain set of train segments over the next hour, and the process 500 may be performed for each train segment in the set. The data accessed for the track segment includes a direction. For example, the direction may be expressed as an angle relative to latitude lines, an angle relative to longitude lines, as a compass direction (e.g., N, NW, WNW), as start and end points from which direction may be determined, or any suitable combination thereof. The track segment data also includes a location of the track segment, such as, for example, a latitude and longitude of the center of the track segment, global positioning system coordinates of beginning and ending points of the track segment, parallel line curves representing the path taken by the tracks through the track segment, or any suitable combination thereof.

In some example embodiments, the dispatcher provides a train identifier, a start location (e.g., track segment or milestone), an end location, and a blow-over rating. A predicted path between the start location and the end location, in conjunction with a speed limit on each track segment, is used to determine, within a margin of error, the time at which the train identified by the train identifier will pass through each track segment on the path. Accordingly, the track segment for which the blow-over risk is being predicted, and the time window for the prediction, may be identified from the information supplied by the dispatcher.

The wind module 220, in operation 520, accesses predicted peak wind vectors at a plurality of locations. Each location of the plurality of locations is selected based on the location of the track segment. For example, sensor stations, each of which has a location, that are within a predetermined distance from the track segment, may be selected.

In operation 530, the wind module 220 determines a predicted peak wind vector at the track segment, based on the predicted peak wind vectors. For example, the predicted peak wind vectors can be averaged using vector averaging or the predicted peak wind speeds and directions can be averaged as separate scalars. In some example embodiments, weights are applied to the predicted wind vectors or scalars based on the distance between each sensor station and the track segment (e.g., an inverse or inverse square relationship), a terrain type of a sensor station, a terrain type of the track segment, a terrain type of a region between a sensor station and the track segment, or any suitable combination thereof.

Using the predicted peak wind vector at the track segment and the direction of the track segment, the wind module 220 provides a blow-over risk assessment (operation 540). The blow-over risk assessment may be provided by the communication module 260 to the alert system(s) 144, the positive train control system(s) 150, the client device 110, or any suitable combination thereof. The blow-over risk assessment may be a percentage risk of blow-over, a control instruction (e.g., proceed normally, proceed at reduced speed, or stop), a color-coded value (e.g., red, green, or yellow), or any suitable combination thereof.

In some example embodiments, the dispatcher provides a train identifier, a start location (e.g., track segment or milestone), an end location, and a blow-over rating. In these example embodiments, the blow-over rating provided by the train dispatcher is used by the wind module 220 in providing the blow-over risk assessment. Additionally or alternatively, the process 500 may be iterated over a set of track segments along a path from the start location to the end location. A resulting blow-over risk assessment for the path based on the blow-over risk assessment provided in operation 540 for each track segment in the path may be provided. For example, the blow-over risk assessment for the path may be the highest risk among the risks for the segments of the path. To illustrate, if a path has three segments with blow-over risks of 90%, 50%, and 10%, the path may be assigned a 90% blow-over risk. As another example, the blow-over risk may be the cumulative probability of blow-over along the path. To illustrate using the three segments of the previous example, the path may be assigned a 95.5% blow-over risk.

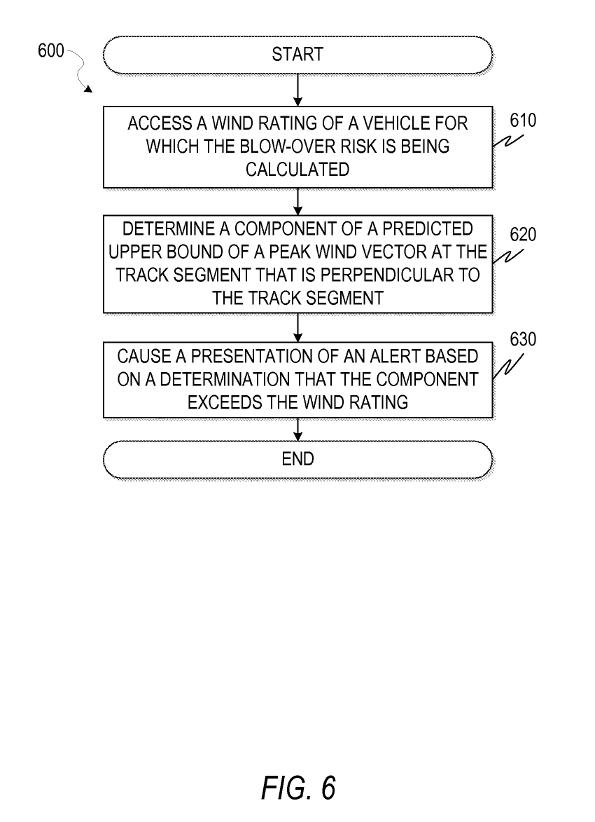

FIG. 6 is a flow diagram illustrating operations of a process 600 implemented in a computer system suitable for assessment of wind-induced train blow-over risk, according to some example embodiments. By way of example and not limitation, the operations of the method 600 are described as being performed by the modules of FIG. 2. In some example embodiments, the process 600 is used in implementing operation 540 of the process 500.

In operation 610, the vehicle module 240 accesses a wind rating of a vehicle for which the blow-over risk is being calculated. For example, a train may have a wind rating of 50, indicating that a cross-wind of 50 MPH or higher carries an unacceptable risk of the train blowing over. The wind rating may be accessed from the database(s) 126 via the database server(s) 124, from a remote server via the network 104, or any suitable combination thereof. In some example embodiments, the vehicle module 240 determines the wind rating of the vehicle from other data. For example, each car in a train may have a separate wind rating, and the wind rating for the train may be based on the wind rating of the component cars. As another example, loading of the vehicle may affect the wind rating, and the vehicle module 240 may calculate the wind rating of the vehicle based on the loading. For example, a full coal car may have a wind rating of 100 MPH while the same car, when empty, has a wind rating of 75 MPH. The vehicle module 240 may determine the actual wind rating of a particular coal car based on the two possible wind ratings in combination with an indication from a dispatcher as to whether the coal car is empty or full.

The wind module 220 determines (in operation 620) a component of the predicted peak wind vector at the track segment that is perpendicular to the track segment. For example, the angle between the direction of the wind and the direction of the track may be determined and the speed of the wind multiplied by the sine of the angle to determine the magnitude of the cross-wind. For winding track segments, the direction of the track segment most nearly perpendicular to the direction of the wind may be used.

The communication module 260 causes a presentation of an alert (e.g., at the client device 110) at operation 630 based on a determination that the perpendicular component exceeds the wind rating. For example, if the predicted peak wind speed at the track is 60 MPH and the angle between the predicted peak wind direction and the track is 80 degrees, the perpendicular component of the wind is 59 MPH. Continuing with the example, since the wind rating for the vehicle is 50 MPH and the perpendicular component of the predicted peak wind vector exceeds the wind rating, an alert is generated. The alert may include the predicted peak wind speed, predicted peak wind direction, location to which the alert applies, an instruction (e.g., “go slow” or “avoid”), or any suitable combination thereof. The location may be identified by a set of mileposts (e.g., Chicago-135 to Chicago-150).

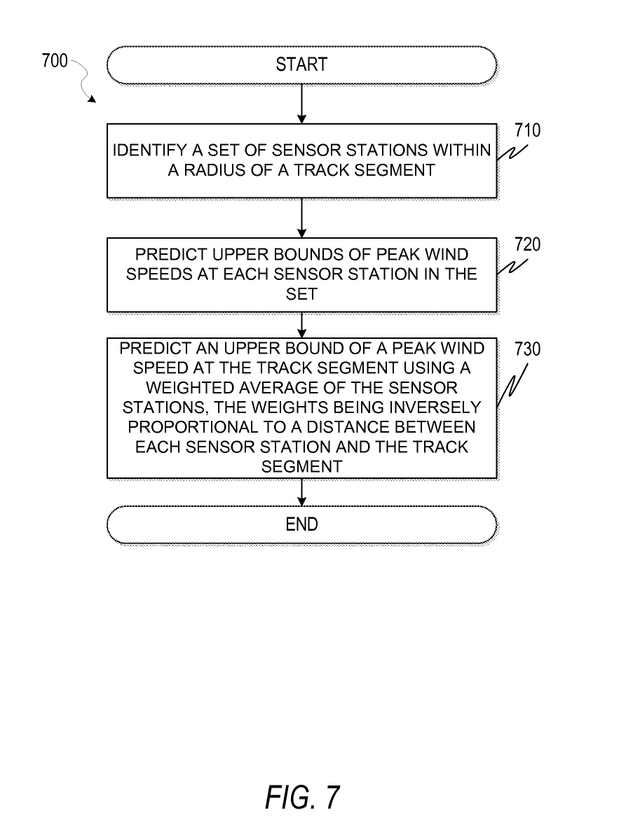

FIG. 7 is a flow diagram illustrating operations of a computer system implementing a process 700 suitable for assessment of wind-induced train blow-over risk, according to some example embodiments. By way of example and not limitation, the operations of the method 700 are described as being performed by the modules of FIG. 2. In some example embodiments, the process 700 is used in implementing operation 520 and 530 of the process 500.

The wind module 220 identifies a set of sensor stations within a predetermined radius of a track segment (operation 710) and predicts peak wind speeds at each sensor station in the set (operation 720). For example, with reference to the graphs of FIG. 3, wind speeds over the previous hour may be used to predict a peak wind speed within a 60 minute window.

In operation 730, the wind module 220 predicts a peak wind speed at the track segment using a weighted average of the predicted peak wind speed at each of the sensor stations in the set. In this example embodiment, the weights are inversely proportional to a distance between each weather station and the track segment. For example, with reference to FIG. 4, the sensor stations 420A-420C may be in the set of sensor stations for the track segment 430A. For this example, the distance between the sensor station 420A and the track segment 430A is 1 mile, the distance between the sensor station 420B and the track segment 430A is 5 miles, and the distance between the sensor station 420C and the track segment 430A is 6 miles. Accordingly, in one example embodiment, the predicted wind speed is determined by giving full weight to the sensor station 420A, ⅕^{th} weight to the sensor station 420B, and ⅙^{th} weight to the sensor station 420C. Thus, the weighted sum of the speeds is 35 (25+9+6), and the weighted average is 25.61 (35 divided by (1+⅕+⅙)). In other example embodiments, additional factors are considered in determining the weights, and different a predicted peak wind speed results.

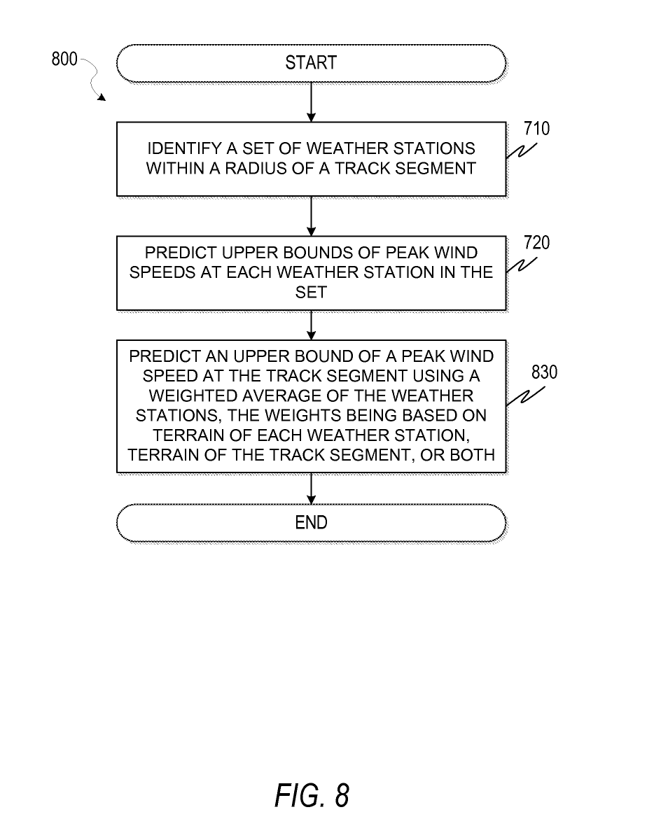

FIG. 8 is a flow diagram illustrating operations of a computer system implementing a process 800 suitable for assessment of wind-induced train blow-over risk, according to some example embodiments. By way of example and not limitation, the operations of the method 800 are described as being performed by the modules of FIG. 2. In some example embodiments, the process 800 is used in implementing operations 520 and 530 of the process 500. Operations 710 and 720 are described above with respect to FIG. 7.

In operation 830, the wind module 220 predicts a peak wind speed at the track segment using a weighted average of the predicted peak wind speed at each of the sensor stations in the set. The weights are based on terrain of the sensor stations, the terrain of the track segment, or both. For example, with reference to FIG. 4, the sensor stations 420A and 420E may be in the set of sensor stations for the track segment 430B. For this example, the terrain of the sensor station 420A and the track segment 430B are normal (e.g., plains) and the terrain of the sensor station 420E is a city region in which speeds are increased by 20%. Accordingly, in one example embodiment, the predicted wind speed is determined by giving full weight to the sensor station 420A, and ⅚^{th} weight to the sensor station 420E. Thus, the weighted sum of the speeds is 35 (25+10), and the weighted average is 17.5 (35 divided by 2). In other example embodiments, additional factors are considered in determining the weights, and different predicted peak wind speed results. For example, weights which are inversely proportional to distance, as described with respect to FIG. 7, and are also based on terrain, as described with respect to FIG. 8, may be used.

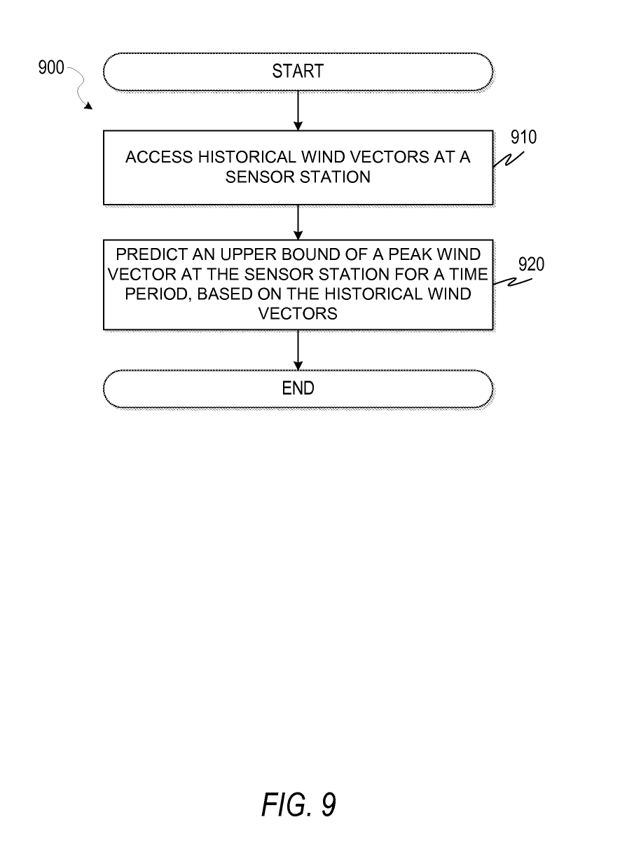

FIG. 9 is a flow diagram illustrating operations of a computer system implementing a process 900 suitable for assessment of wind-induced train blow-over risk, according to some example embodiments. By way of example and not limitation, the operations of the method 900 are described as being performed by the modules of FIG. 2. In some example embodiments, the process 900 is used in implementing operation 510 of the process 500.

In operation 910, the wind module 220 accesses historical wind vectors at a sensor station. For example, with reference to FIG. 4, the wind speed at the weather station over the previous hour may be accessed. Each speed data point in the graphs of FIG. 4 may have a corresponding direction (not shown), which is also accessed. Based on the historical wind vectors, the wind module 220 predicts a peak wind vector at the sensor station for a future time period (operation 920). For example, an auto-regression model may have been calibrated using the historical data and applied to one or more recent time periods (e.g., the previous hour as a single period or the previous 30 minutes and the 30 minutes prior to that as separate periods) to generate a predicted peak wind vector for the future time period (e.g., the period beginning in 30 minutes and ending 30 minutes later).

FIG. 10 is a flow diagram illustrating operations of a computer system implementing a process 1000 suitable for assessment of wind-induced train blow-over risk, according to some example embodiments. By way of example and not limitation, the operations of the process 1000 are described as being performed by the modules of FIG. 2.

In operation 1010, the track module 210 accesses data for a track segment for which blow-over risk will be determined. The track segment may be identified based on a train schedule. For example, a train may be scheduled to cross a certain set of train segments over the next hour, and the process 1000 may be performed for each train segment in the set. The data accessed for the track segment includes a direction. For example, the direction may be expressed as an angle relative to latitude lines, an angle relative to longitude lines, as a compass direction (e.g., N, NW, WNW), as start and end points from which direction may be determined, or any suitable combination thereof. The track segment data also includes a location of the track segment, such as, for example, a latitude and longitude of the center of the track segment, global positioning system coordinates of beginning and ending points of the track segment, parallel line curves representing the path taken by the tracks through the track segment, or any suitable combination thereof.

In some example embodiments, the dispatcher provides a train identifier, a start location (e.g., track segment or milestone), an end location, and a blow-over rating. A predicted path between the start location and the end location, in conjunction with a speed limit on each track segment, is used to determine, within a margin of error, the time at which the train identified by the train identifier will pass through each track segment on the path. Accordingly, the track segment for which the blow-over risk is being predicted, and the time window for the prediction, may be identified from the information supplied by the dispatcher.

The wind module 220, in operation 1020, accesses observed wind vectors at a plurality of locations. Each location of the plurality of locations is selected based on the location of the track segment. For example, sensor stations, each of which has a location, that are within a predetermined distance from the track segment, may be selected.

In operation 1030, the wind module 220 determines a predicted upper bound on the peak wind vector at the track segment, based on the observed wind vectors. For example, the observed wind vectors can be averaged using vector averaging or the observed wind speeds and directions can be averaged as separate scalars. In some example embodiments, weights are applied to the observed wind vectors or scalars based on the distance between each sensor station and the track segment (e.g., an inverse or inverse square relationship), a terrain type of a sensor station, a terrain type of the track segment, a terrain type of a region between a sensor station and the track segment, or any suitable combination thereof.

The observed wind vectors, composed of wind speed and wind direction, may be decomposed into two separate values, which may be used instead of or in addition to the wind vector value itself. Additionally or alternatively, other data values from the sensor locations may be used, such as wind gust, temperature, precipitation, or any suitable combination thereof. The sensors may be airport weather stations, personal weather stations sourced from a weather aggregator, anemometers set up along a track by the railroad operator, or any suitable combination thereof. In some example embodiments, a list of weather stations and anemometers for a given section of track is identified using a proximity measure. For example, all weather stations and anemometers within a 40 mile radius of a milepost of a track section may be associated with that track section.

In some example embodiments applying the process 1000, a wind forecasting model for the track section is created by the training module 250. The model is generated from historical data available for the sensor stations associated with the track section. The model is set up to predict the upper bound on the maximum wind speed at the track section in a given forecast interval (e.g., 15-30 minutes ahead, 30-60 minutes ahead, or another future interval).

In some example embodiments, the prediction may be based on the maximum wind speed observed across all of the associated sensor stations within a preceding interval. For example, if five sensor stations are associated with a track segment and the maximum wind speed observed at those stations over the preceding hour were 35 mph, 40 mph, 37 mph, 23 mph, and 28 mph, respectively, then the highest value of 40 mph would be used as an input to the maximum wind speed upper bound forecast for the track segment.

In other example embodiments, the predictions are based on other values in addition to or instead of the observed maximum wind speed. For example, the standard deviation of the maximum values reported by the individual anemometers could be used as an input (e.g., a higher standard deviation could indicate a higher risk of gusts). As another example, the observed maximum wind speeds over one or more additional previous periods could be used (e.g., the immediately preceding hour, the second preceding hour, the third preceding hour).

Historical data may be used as training observations to train the forecasting model, which may include constraints as well as costs. Consider an example model of

y=a+Σwᵢxᵢ,

wherein y is the predicted maximum wind speed at the track segment, a and wᵢ are constants, and each xᵢ is an observed value for feature i (e.g., the maximum wind speed in the previous hour among all sensors associated with the track segment, the standard deviation between the maximum observed wind speeds, or another value). In some example embodiments, calibration of the a and wᵢ values may be performed by minimizing a cost function associated with differences between predicted y values and observed values at the track segment. The cost table below may be used.

| Condition | Cost |
|---|---|
| y_{actual} > y_{t,}, yₚ > y_{actual} | 0 |
| y_{actual} > y_{t,}, yₚ < Y_{actual} | C_{T} * (y_{actual} − yₚ) |
| y_{actual} < y_{t,}, yₚ < Yₜ | 0 |
| y_{actual} < y_{t,}, yₚ > Yₜ | C_{F} * (yₚ − y_{actual}) |

In the above table, y_{actual} is the actual observed maximum value of wind speed at a time instant, yₚ is the predicted maximum wind value, and yₜ is a threshold wind speed above which high accuracy is important to achieve. A linear or quadratic programming approach can be used to determine the w using the above cost functions.

As another example cost function, consider:

$${\sum }_{j} {β}_{j} * {( {y}_{j} - a - {\sum }_{i} {w}_{i} {x}_{ij} )}^{2}$$

An example cost table that can be used with the above function is listed below:

| Condition | βⱼ |
|---|---|
| y_{actual} > y_{t,} | 10 |
| y_{actual} < yₜ | 1 |

βⱼ is the cost associated with each time instant j as defined in the example in the above table, yⱼ is the observed value, i=feature number, j=time point, wᵢ is the coefficient for feature i. This cost function gives much higher emphasis to high wind speed values, thus making sure that the model does better in predicting high wind speeds, which is the main objective of the algorithm

In some example embodiments, a wind model is created for each individual sensor. The model form for each sensor may use an equation of the form, y=a+Σwᵢxᵢ, as described above, with the xᵢ values determined for the individual sensor. The upper bound on the predicted maximum wind speed for each sensor is then combined to develop an estimate of the maximum wind speed predicted for the associated track section in the forecast algorithm. One example method of combining the predicted maximum wind speed for each sensor is to take the maximum value from among the predicted maxima and use that maximum-of-maximums value as the predicted upper bound on the maximum speed for the track segment.

Using the predicted upper bound on the maximum wind speed at the track segment, the wind module 220 provides a blow-over risk assessment (operation 1040). The blow-over risk assessment may be provided by the communication module 260 to the alert system(s) 144, the positive train control system(s) 150, the client device 110, or any suitable combination thereof. The blow-over risk assessment may be a percentage risk of blow-over, a control instruction (e.g., proceed normally, proceed at reduced speed, or stop), a color-coded value (e.g., red, green, or yellow), or any suitable combination thereof.

In some example embodiments, the dispatcher provides a train identifier, a start location (e.g., track segment or milestone), an end location, and a blow-over rating. In these example embodiments, the blow-over rating provided by the train dispatcher is used by the wind module 220 in providing the blow-over risk assessment. Additionally or alternatively, the process 1000 may be iterated over a set of track segments along a path from the start location to the end location. A resulting blow-over risk assessment for the path based on the blow-over risk assessment provided in operation 1040 for each track segment in the path may be provided. For example, the blow-over risk assessment for the path may be the highest risk among the risks for the segments of the path. To illustrate, if a path has three segments with blow-over risks of 90%, 50%, and 10%, the path may be assigned a 90% blow-over risk. As another example, the blow-over risk may be the cumulative probability of blow-over along the path. To illustrate using the three segments of the previous example, the path may be assigned a 95.5% blow-over risk.

### Modules, Components, and Logic

Certain embodiments are described herein as including logic or a number of components, modules, or mechanisms. Modules may constitute hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-10 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things” while yet another combination produces a server computer for use within a cloud computing architecture. Not all combinations of such software and hardware architectures are presented here as those of skill in the art can readily understand how to implement the inventive subject matter in different contexts from the disclosure contained herein.

### Software Architecture

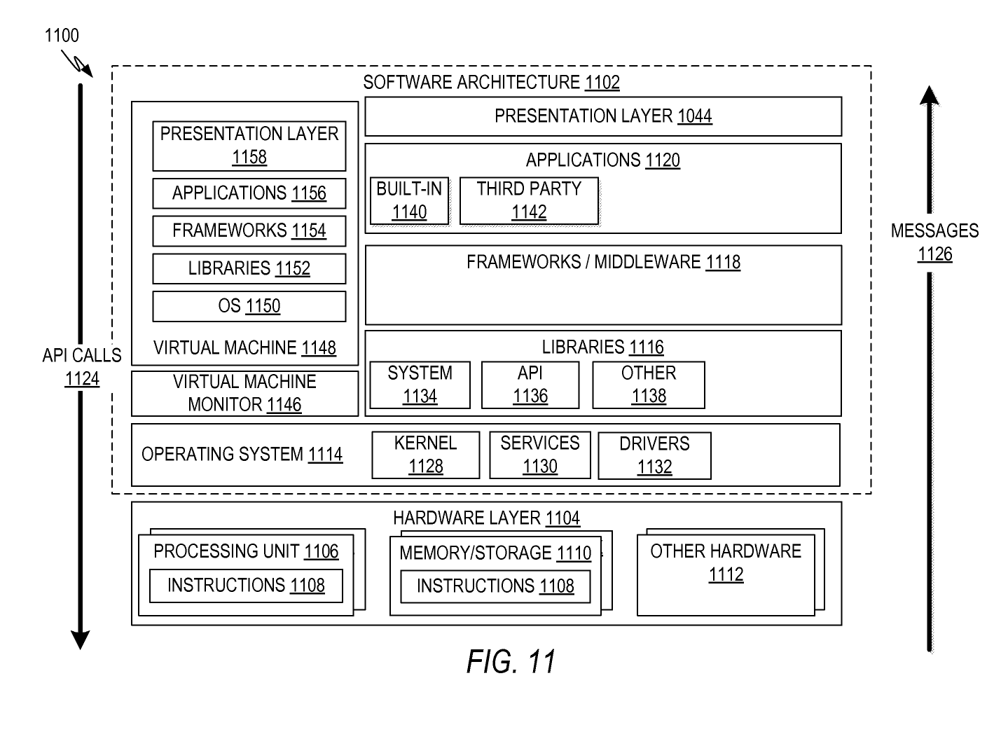

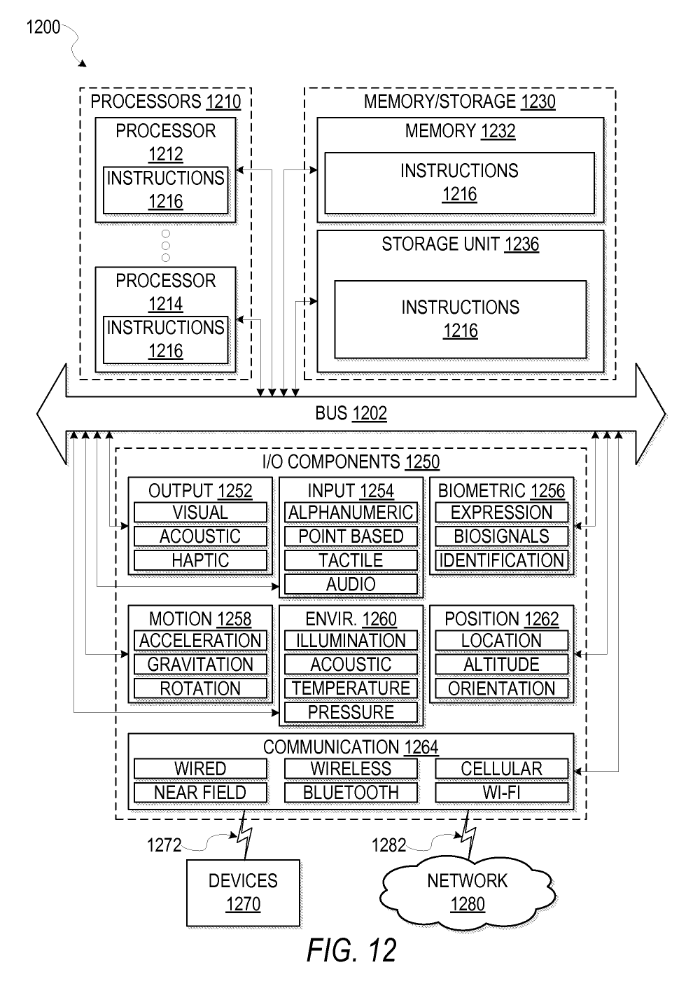

FIG. 11 is a block diagram 1100 illustrating a representative software architecture 1102, which may be used in conjunction with various hardware architectures herein described. FIG. 11 is merely a non-limiting example of a software architecture, and it will be appreciated that many other architectures may be implemented to facilitate the functionality described herein. The software architecture 1102 may be executing on hardware such as machine 1200 of FIG. 12 that includes, among other things, processors 1210, memory/storage 1230, and I/O components 1250. A representative hardware layer 1104 is illustrated and can represent, for example, the machine 1200 of FIG. 12. The representative hardware layer 1104 comprises one or more processing units 1106 having associated executable instructions 1108. Executable instructions 1108 represent the executable instructions of the software architecture 1102, including implementation of the methods, modules and so forth of FIGS. 1-10. Hardware layer 1104 also includes memory or storage modules 1110, which also have executable instructions 1108. Hardware layer 1104 may also comprise other hardware 1112 which represents any other hardware of the hardware layer 1104, such as the other hardware illustrated as part of machine 1200.

In the example architecture of FIG. 11, the software architecture 1102 may be conceptualized as a stack of layers where each layer provides particular functionality. For example, the software architecture 1102 may include layers such as an operating system 1114, libraries 1116, frameworks/middleware 1118, applications 1120 and presentation layer 1144. Operationally, the applications 1120 or other components within the layers may invoke application programming interface (API) calls 1124 through the software stack and receive a response, returned values, and so forth illustrated as messages 1126 in response to the API calls 1124. The layers illustrated are representative in nature, and not all software architectures have all layers. For example, some mobile or special purpose operating systems may not provide a frameworks/middleware layer 1118, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware layer 1104 and the other software layers. For example, the kernel 1128 may be responsible for memory management, processor management (e.g., scheduling), component management, networking, security settings, and so on. The services 1130 may provide other common services for the other software layers. The drivers 1132 may be responsible for controlling or interfacing with the underlying hardware. For instance, the drivers 1132 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1116 may provide a common infrastructure that may be utilized by the applications 1120 or other components or layers. The libraries 1116 typically provide functionality that allows other software modules to perform tasks in an easier fashion than to interface directly with the underlying operating system 1114 functionality (e.g., kernel 1128, services 1130 or drivers 1132). The libraries 1116 may include system libraries 1134 (e.g., C standard library) that may provide functions such as memory allocation functions, string manipulation functions, mathematic functions, and the like. In addition, the libraries 1116 may include API libraries 1136 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules.

The frameworks/middleware 1118 (also sometimes referred to as middleware) may provide a higher-level common infrastructure that may be utilized by the applications 1120 or other software components/modules. For example, the frameworks/middleware 1118 may provide various graphic user interface (GUI) functions, high-level resource management, high-level location services, and so forth. The frameworks/middleware 1118 may provide a broad spectrum of other APIs that may be utilized by the applications 1120 or other software components/modules, some of which may be specific to a particular operating system or platform.

The applications 1120 include built-in applications 1140 or third party applications 1142. Examples of representative built-in applications 1140 include, but are not limited to, a contacts application, a browser application, a book reader application, a location application, a media application, a messaging application, or a game application. Third party applications 1142 may include any of the built-in applications 1140 as well as a broad assortment of other applications. In a specific example, the third party application 1142 (e.g., an application developed using the Android™ or iOS™ software development kit (SDK) by an entity other than the vendor of the particular platform) is mobile software running on a mobile operating system such as iOS™, Android™, Windows® Phone, or other mobile operating systems. In this example, the third party application 1142 invokes the API calls 1124 provided by the mobile operating system such as operating system 1114 to facilitate functionality described herein. The track module 210, wind module 220, terrain module 230, vehicle module 240, training module 250, and communication module 260 of the forecast system(s) 142 may be implemented as one or more third party applications 1142.

The applications 1120 may utilize built-in operating system functions (e.g., kernel 1128, services 1130 and/or drivers 1132), libraries (e.g., system 1134, API libraries 1136, and other libraries 1138), frameworks/middleware 1118 to create user interfaces to interact with users of the system. Alternatively, or additionally, in some systems interactions with a user may occur through a presentation layer, such as presentation layer 1144. In these systems, the application/module “logic” can be separated from the aspects of the application/module that interact with a user.

Some software architectures utilize virtual machines. In the example of FIG. 11, this is illustrated by virtual machine 1148. A virtual machine creates a software environment where applications/modules can execute as if they were executing on a hardware machine (e.g., such as the machine of FIG. 12). A virtual machine is hosted by a host operating system (e.g., operating system 1114 in FIG. 11) and typically, although not always, has a virtual machine monitor 1146, which manages the operation of the virtual machine as well as the interface with the host operating system (e.g., operating system 1114). A software architecture executes within the virtual machine 1148 such as an operating system 1150, libraries 1152, frameworks/middleware 1154, applications 1156 or presentation layer 1158. These layers of software architecture executing within the virtual machine 1148 can be the same as corresponding layers previously described or may be different.

### Example Machine Architecture and Machine-Readable Medium

FIG. 12 is a block diagram illustrating components of a machine 1200, according to some example embodiments, able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system, within which instructions 1216 (e.g., software, a program, an application, an applet, an app, or other executable code) for causing the machine 1200 to perform any one or more of the methodologies discussed herein may be executed. For example the instructions may cause the machine to execute the flow diagrams of FIGS. 1-9. Additionally or alternatively, the instructions may implement the track module 210, the wind module 220, the terrain module 230, the vehicle module 240, and the communication module 260 of FIG. 2. The instructions transform the general, non-programmed machine into a particular machine programmed to carry out the described and illustrated functions in the manner described. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but is not limited to, a server computer, a client computer, a personal computer (PC), or any machine capable of executing the instructions 1216, sequentially or otherwise, that specify actions to be taken by machine 1200. Further, while only a single machine 1200 is illustrated, the term “machine” shall also be taken to include a collection of machines 1200 that individually or jointly execute the instructions 1216 to perform any one or more of the methodologies discussed herein.

The machine 1200 may include processors 1210, memory/storage 1230, and I/O components 1250, which may be configured to communicate with each other such as via a bus 1202. In an example embodiment, the processors 1210 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1212 and processor 1214 that may execute instructions 1216. The term “processor” is intended to include multi-core processors that comprise two or more independent processors (sometimes referred to as “cores”) that may execute instructions contemporaneously. Although FIG. 12 shows multiple processors, the machine 1200 may include a single processor with a single core, a single processor with multiple cores, multiple processors with a single core, multiple processors with multiples cores, or any combination thereof.

The memory/storage 1230 may include a memory 1232, such as a main memory, or other memory storage, and a storage unit 1236, each accessible to the processors 1210, such as via the bus 1202. The storage unit 1236 and memory 1232 store the instructions 1216 embodying any one or more of the methodologies or functions described herein. The instructions 1216 may also reside, completely or partially, within the memory 1232, within the storage unit 1236, within at least one of the processors 1210 (e.g., within the processor's cache memory), or any suitable combination thereof, during execution thereof by the machine 1200. Accordingly, the memory 1232, the storage unit 1236, and the memory of processors 1210 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store instructions 1216. The term “machine-readable medium” shall also be taken to include any medium, or combination of multiple media, that is capable of storing instructions (e.g., instructions 1216) for execution by a machine (e.g., machine 1200), such that the instructions, when executed by one or more processors of the machine 1200 (e.g., processors 1210), cause the machine 1200 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1250 may include a wide variety of components to receive input, provide output, produce output, transmit information, exchange information, capture measurements, and so on. The specific I/O components 1250 that are included in a particular machine will depend on the type of machine. For example, portable machines such as mobile phones will likely include a touch input device or other such input mechanisms, while a headless server machine will likely not include such a touch input device. It will be appreciated that the I/O components 1250 may include many other components that are not shown in FIG. 12. The I/O components 1250 are grouped according to functionality merely for simplifying the following discussion, and the grouping is in no way limiting. In various example embodiments, the I/O components 1250 may include output components 1252 and input components 1254. The output components 1252 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1254 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location or force of touches or touch gestures, or other tactile input components), audio input components (e.g., a microphone), and the like.

In further example embodiments, the I/O components 1250 may include biometric components 1256, motion components 1258, environmental components 1260, or position components 1262 among a wide array of other components. For example, the biometric components 1256 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1258 may include acceleration sensor components (e.g., accelerometer), gravitation sensor components, rotation sensor components (e.g., gyroscope), and so forth. The environmental components 1260 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1262 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1250 may include communication components 1264 operable to couple the machine 1200 to a network 1280 or devices 1270 via coupling 1282 and coupling 1272 respectively. For example, the communication components 1264 may include a network interface component or other suitable device to interface with the network 1280. In further examples, communication components 1264 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1270 may be another machine or any of a wide variety of peripheral devices (e.g., a peripheral device coupled via a Universal Serial Bus (USB)).

Moreover, the communication components 1264 may detect identifiers or include components operable to detect identifiers. For example, the communication components 1264 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1264, such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1280 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1280 or a portion of the network 1280 may include a wireless or cellular network, and the coupling 1282 may be a Code Division Multiple Access (CDMA) connection, a Global System for Mobile communications (GSM) connection, or other type of cellular or wireless coupling. In this example, the coupling 1282 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1216 may be transmitted or received over the network 1280 using a transmission medium via a network interface device (e.g., a network interface component included in the communication components 1264) and utilizing any one of a number of well-known transfer protocols (e.g., hypertext transfer protocol (HTTP)). Similarly, the instructions 1216 may be transmitted or received using a transmission medium via the coupling 1272 (e.g., a peer-to-peer coupling) to devices 1270. The term “transmission medium” shall be taken to include any intangible medium that is capable of storing, encoding, or carrying instructions 1216 for execution by the machine 1200, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
training a prediction algorithm for an upper bound of wind speed at a track segment having a direction, the training of the prediction algorithm minimizing a cost function wherein prediction errors for wind speeds above a threshold have a different cost than prediction errors for wind speeds below the threshold;
accessing data representing the track segment;
accessing data representing past wind speeds and corresponding directions at each location of a plurality of locations;
determining, by one or more hardware processors applying the trained prediction algorithm, a predicted upper bound of wind speed and corresponding direction at the track segment based on the past wind speeds and corresponding directions at the plurality of locations; and
causing a presentation of a blow-over risk, the blow-over risk being based on the predicted upper bound of wind speed and the corresponding direction at the track segment and the direction of the track segment.

2. The method of claim 1, further comprising:
determining the blow-over risk based on a rating of a vehicle associated with the track segment.

3. The method of claim 1, wherein:
the blow-over risk is further based on an angle between the direction of the track segment and the corresponding direction to the predicted upper bound of wind speed at the track segment.

4. The method of claim 1, wherein:
the determining of the predicted upper bound of wind speed at the track segment determines the predicted upper bound of wind speed at the track segment based on distances between the track segment and the plurality of locations.

5. The method of claim 1, wherein:
the determining of the predicted upper bound of wind speed at the track segment determines the predicted upper bound of wind speed at the track segment based on a terrain type of the track segment.

6. The method of claim 1, wherein:
the determining of the predicted upper bound of wind speed at the track segment determines the predicted upper bound of wind speed at the track segment based on terrain types of the plurality of locations.

7. The method of claim 1, further comprising:
determining the corresponding direction to the predicted upper bound of wind speed at each location of the plurality of locations based on a historical average of wind direction for each location.

8. The method of claim 1, further comprising:
determining the corresponding direction to the predicted upper bound of wind speed at each location of the plurality of locations based on an autoregressive model for each location.

9. The method of claim 1, wherein:
the track segment is one of a plurality of track segments, each track segment of the plurality of track segments having a direction; and
the blow-over risk is further based on predicted upper bound of wind speeds at each of the other track segments of the plurality of track segments, the direction of each of the other track segments of the plurality of track segments, and a direction corresponding to a predicted upper bound of wind speed at each of the other track segments of the plurality of track segments.

10. The method of claim 1, wherein:
prediction errors for observed wind speeds below the predicted upper bound of wind speed have no cost.

11. The method of claim 1, wherein:
prediction errors for observed wind speeds below the threshold have no cost when the predicted upper bound of wind speed is also below the threshold.

12. The method of claim 1, wherein:
the cost of under-predicting a observed maximum wind speed which is above the threshold is different than the cost of over-predicting the observed maximum wind speed which is below the threshold.

13. A system comprising:
a training module configured to:
train a prediction algorithm for wind speed at a track segment having a direction, the training of the prediction algorithm minimizing a cost function wherein prediction errors for wind speeds above a threshold have a different cost than prediction errors for wind speeds below the threshold;
a track module configured to:
access data representing a track segment having a direction;
a hardware-implemented wind module configured to:
access data representing a past wind speed and corresponding direction at each location of a plurality of locations;
determine, by applying the trained prediction algorithm, a predicted upper bound of wind speed and corresponding direction at the track segment based on the past wind speeds at the plurality of locations; and
a communication module configured to:
cause a presentation of a blow-over risk, the blow-over risk being based on the predicted upper bound of wind speed and the corresponding direction at the track segment and the direction of the track segment.

14. The system of claim 13, wherein the wind module is further configured to:
determine the blow-over risk based on a rating of a vehicle associated with the track segment.

15. The system of claim 13, wherein:
the blow-over risk is further based on an angle between the direction of the track segment and the corresponding direction to the predicted upper bound of wind speed at the track segment.

16. The system of claim 13, wherein:
the determining of the predicted peak wind speed at the track segment by the wind module determines the predicted upper bound of wind speed at the track segment based on distances between the track segment and the plurality of locations.

17. The system of claim 13, wherein:
the determining of the predicted upper bound of wind speed at the track segment by the wind module determines the predicted upper bound of wind speed at the track segment based on a terrain type of the track segment.

18. The system of claim 13, wherein:
the determining of the predicted upper bound of wind speed at the track segment by the wind module determines the predicted upper bound of wind speed at the track segment based on terrain types of the plurality of locations.

19. The system of claim 13, wherein the wind module is further configured to:
determine the corresponding direction to the predicted upper bound of wind speed at each location of the plurality of locations based on a historical average of wind direction for each location.

20. A machine-readable medium not having any transitory signals and having instructions embodied thereon which, when executed by one or more processors of a machine, cause the machine to perform operations comprising:
training a prediction algorithm for wind speed at a track segment having a direction, the training of the prediction algorithm minimizing a cost function wherein prediction errors for wind speeds above a threshold have a different cost than prediction errors for wind speeds below the threshold;
accessing data representing the track segment;
accessing data representing past wind speeds at each location of a plurality of locations;
determining, by applying the trained prediction algorithm, a predicted upper bound of wind speed and corresponding direction at the track segment based on the past wind speeds at the plurality of locations; and
causing a presentation of a blow-over risk, the blow-over risk being based on the predicted upper bound of wind speed and the corresponding direction at the track segment and the direction of the track segment.
